(19) United States
(12) Patent Application Publication
(10) Pub. No.: US 2024/0404749 A1
(43) Pub. Date: Dec. 5, 2024

(54) TECHNIQUES FOR PATTERNING FERRITE MATERIALS

(71) Applicant: Metamagnetics Inc., Marlborough, MA (US)

(72) Inventors: Alexander Sokolov, Wakefield, MA (US); Ronald Harish Chand, Plymouth, MA (US); Jacob G. Remz, Marlborough, MA (US)

(73) Assignee: Metamagnetics Inc., Marlborough, MA (US)

(21) Appl. No.: 18/678,512

(22) Filed: May 30, 2024

Related U.S. Application Data
(60) Provisional application No. 63/504,865, filed on May 30, 2023.

(51) Int. Cl. H01F 41/02; B23K 26/38; B23K 26/402; B28D 5/02

(52) U.S. Cl. CPC H01F 41/0206; B23K 26/38; B23K 26/402; B28D 5/022

(57) ABSTRACT

Systems, methods, and techniques for patterning an assembly having a ferrite layer and a substrate using a blade or LASER beam to make cuts in the ferrite layer to form active regions of the ferrite layer and inactive regions of the ferrite layer. The cuts may be configured to relieve strain in the ferrite lattice structure. The cuts may be configured to achieve desired RF operating characteristic for the ferrite layer.

### CROSS-REFERENCE TO RELATED APPLICATION

This application claims the benefit of priority to U.S. Provisional Application No. 63/504,865, filed on May 30, 2023, which is hereby incorporated herein by reference in its entirety.

### BACKGROUND

Ferrite materials used in radio frequency (RF)/microwave devices are typically treated as a single body (e.g., substrate, superstrate, bulk), where an active area is defined using the outer-most physical dimensions of the material, circuit pattern, or combination thereof. One problem with this approach is that to make smaller structures and/or smaller features of active ferrite parts, increasingly complex ceramic machining tools and equipment are needed. Use of such higher complexity ceramic machining tools and equipment leads to higher cost tooling and manufacturing methods.

Ferrite films are typically thin enough, e.g., less than about 3 microns in thickness, so that chemical etching can be used to pattern a device. However, chemical etching may be unable to pattern thick, e.g., more than 10 microns thick, ferrite layers. In addition, chemical etching can result in rounded corners and imprecise edges. It will be readily appreciated that RF device performance can be impacted by undesired structures and surface configurations.

### SUMMARY

Disclosed are example systems, methods, and techniques for patterning ferrite materials. In particular, described are example systems, methods, and techniques for mechanically or optically patterning ferrite materials. Using the systems, methods, and techniques disclosed herein, a thicker (e.g., more than 10 microns thick) ferrite layer may be patterned using tools similar to, or the same as, tools used in semiconductor wafer processing. Systems, methods, and techniques disclosed herein may also allow for more precise patterning of a ferrite layer. For example, Light Amplification by Stimulated Emission of Radiation (LASER) patterning techniques using a LASER beam and/or mechanical patterning techniques using a wafer dicing saw, ceramic surface grinder, and/or cutter may be used to pattern a ferrite layer. Using the systems, methods, and techniques disclosed herein, the need for using complex ceramic machine tools and equipment or chemical etching when processing ferrite materials may be reduced or eliminated.

In accordance with some embodiments, there is provided a method. The method comprises receiving a pattern for an assembly having a ferrite layer and a dielectric layer, and mechanically or optically making cuts in the ferrite layer to form active regions of the ferrite layer and inactive regions of the ferrite layer.

In some embodiments, first ones of the cuts extend partially into the dielectric layer. In further embodiments, second ones of the cuts extend at least half way through the dielectric layer.

In still further embodiments, the assembly comprises a binder between the ferrite layer and the dielectric layer.

In some embodiments, the ferrite layer is at least 1 microns in thickness. In further embodiments, at least one of the cuts in the ferrite layer is configured to relieve strain in a lattice of the ferrite layer.

In still further embodiments, the method further includes selecting a profile of a blade or LASER beam for making at least some of the cuts.

In some embodiments, the method further includes selecting a profile of a blade for making at least some of the cuts, wherein selecting the profile of the blade includes selecting an abrasive characteristic of the blade.

In further embodiments, selecting the profile includes selecting a shape of the blade or LASER beam for some of the cuts to have a particular geometry.

In still further embodiments, the particular geometry is at least partially non-linear.

In some embodiments, the particular geometry is at least partially arcuate.

In further embodiments, the particular geometry requires at least two passes by the blade or LASER beam.

In still further embodiments, at least some of the cuts are beveled.

In some embodiments, at least some of the cuts are configured for at least one radio frequency (RF) operating characteristic.

In further embodiments, the method further includes selecting a profile of a LASER beam for making at least some of the cuts, wherein selecting the profile of the LASER beam includes selecting one of a wavelength of the LASER beam, an energy of the LASER beam, or a shape of the LASER beam.

In still further embodiments, the method further includes selecting a profile of a LASER beam for making at least some of the cuts, wherein selecting the profile of the LASER beam includes selecting a shape of a beam for some of the cuts to have a particular geometry.

Furthermore, in accordance with some embodiments, there is provided a system. The system comprises a memory storing instructions and one or more processors. The one or more processors, when executing the instructions, are configured to receive a pattern for an assembly having a ferrite layer and a dielectric layer, and to mechanically or optically make cuts in the ferrite layer to form active regions of the ferrite layer and inactive regions of the ferrite layer.

In some embodiments, first ones of the cuts extend partially into the dielectric layer. In further embodiments, second ones of the cuts extend at least half way through the dielectric layer.

In still further embodiments, the assembly comprises a binder between the ferrite layer and the dielectric layer.

In some embodiments, the ferrite layer is at least 1 microns in thickness.

In further embodiments, at least one of the cuts in the ferrite layer is configured to relieve strain in a lattice of the ferrite layer.

In still further embodiments, the system is further configured for a profile of a blade or LASER beam for making at least some of the cuts.

In some embodiments, the profile of the blade includes an abrasive characteristic of the blade.

In further embodiments, the profile includes a shape of the blade or LASER beam for some of the cuts to have a particular geometry.

In still further embodiments, the particular geometry is at least partially non-linear.

In some embodiments, the particular geometry is at least partially arcuate.

In further embodiments, the particular geometry requires at least two passes by the blade or LASER beam.

In still further embodiments, at least some of the cuts are beveled.

In some embodiments, at least some of the cuts are configured for at least one radio frequency (RF) operating characteristic.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, was well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures.

FIG. 1A shows a diagram of a cross-sectional view of an example assembly comprising a ferrite disposed on a dielectric wafer before patterning.

FIG. 1B shows a diagram of a cross-sectional view of an example assembly comprising a ferrite disposed on a dielectric wafer after patterning.

FIG. 1C shows a diagram of a top view of an example assembly with different types of cuts.

FIG. 2A shows a diagram of a cross-sectional view of an example assembly having cuts with wedge shapes.

FIG. 2B shows a diagram of a cross-sectional view of another example assembly having cuts with wedge shapes.

FIG. 3A shows a diagram of a cross-sectional view of an example assembly having cuts with bevels.

FIG. 3B shows a diagram of a cross-sectional view of an example assembly having a V-shaped cut.

FIG. 4A shows a diagram of a cross-sectional view of an example assembly having a cut with a compound surface.

FIG. 4B shows a diagram of a cross-sectional view of an assembly having a cut with a compound surface.

FIG. 4C shows a diagram of orientations of a cutting tool for multiple cutting passes.

FIG. 5 shows a flow diagram of an example process for patterning an assembly having a ferrite layer, consistent with embodiments of the present disclosure.

FIG. 6 shows a diagram of an example system that can pattern an assembly, consistent with embodiments of the present disclosure; and

FIG. 7 shows a diagram of an example computing device that can perform at least a portion of the methods and techniques described herein.

### DETAILED DESCRIPTION

Reference will now be made in detail to the embodiments of the disclosure, certain examples of which are illustrated in the accompanying drawings.

In the following description, numerous specific details are set forth regarding the systems, methods, and techniques of the disclosed subject matter, and the environment in which such systems, methods, and techniques operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems, methods, and techniques described herein. In addition, it will be understood that the embodiments provided below are examples, and that it is contemplated that there are other systems, methods, and techniques that are within the scope of the subject matter disclosed herein.

Before describing the broad concepts, systems, and techniques sought to be protected herein, some information is provided. Ferrite materials may be single crystal films and/or polycrystalline ceramic materials, which are usually quite brittle. As such, they may require some supporting growth substrate or mechanical substrate (e.g., dielectric and/or ferrite). Ferrite materials may be fabricated by mixing and firing large proportions of iron oxide and metallic materials, such as nickel, manganese, barium, strontium, and zinc. Ferrites are ferrimagnetic, i.e., capable of being magnetized or attracted to a magnet. Ferrite materials, especially ferrite oxides, are typically not electrically conductive which makes them suitable as transformer cores and as low-loss materials in RF applications. Hard ferrites (e.g., strontium ferrites, barium ferrites, blends of strontium ferrites and/or barium ferrites with one or more dopants) may have high coercivity and thus may be difficult to demagnetize. Soft ferrites (e.g., nickel ferrites, zinc ferrites, manganese ferrites, Yttrium Iron Garnet (YIG), Lithium ferrite) may have low coercivity, and thus may be susceptible to magnetization changes. Soft ferrites may act as conductors of magnetic fields useful as magnetic cores for inductors, transformers, antennas, etc.

Ferrite materials used in radio frequency (RF)/microwave devices are typically treated as a single body (e.g., substrate, superstrate, bulk), where the active area is defined using the outer-most physical dimensions of the material, circuit pattern, or combination thereof. One problem with this approach is that to make smaller structures and/or smaller features of active ferrite parts, increasingly complex ceramic machining tools and equipment are needed. Use of such higher complexity ceramic machining tools and equipment leads to higher cost tooling and manufacturing methods.

Ferrite films are typically thin enough, e.g., less than about 3 microns in thickness, so that chemical etching can be used to pattern a device. However, chemical etching may be unable to pattern thick, e.g., more than 10 microns thick, ferrite layers. In addition, chemical etching can result in rounded corners and imprecise edges. It will be readily appreciated that RF device performance can be impacted by undesired structures and surface configurations.

In order to provide higher data rates and capacity, wireless technologies have been moving toward utilizing higher frequencies. Sending and receiving wireless signals at these higher frequencies requires smaller features (e.g., ferrite features), due to the shorter wavelengths of the signals. As a result, a need for techniques for creating small (e.g., less than 1 mm) and/or complex-shaped ferrite parts has recently emerged. Additionally, separately processing ferrite films to create ferrite features and other substrates, such as semiconductor wafers to create semiconductor features, may be expensive and inefficient. It would be beneficial to provide techniques for processing ferrite films that make this processing more efficient and less costly.

The systems, methods, and techniques disclosed herein can address the above issues in processing ferrite features. Disclosed are example systems, methods, and techniques for patterning ferrite materials. In particular, described are example systems, methods, and techniques for mechanically or optically patterning ferrite materials. Using the systems, methods, and techniques disclosed herein, a thicker (e.g., more than 10 microns thick) ferrite layer may be patterned using tools similar to or the same as tools used in processing other types of substrates, such as tools used in semiconductor wafer processing. Systems, methods, and techniques disclosed herein may also allow for more precise patterning of a ferrite layer. For example, Light Amplification by Stimulated Emission of Radiation (LASER) patterning techniques and/or mechanical patterning techniques using a wafer dicing saw, ceramic surface grinder, and/or cutter may be used to pattern a ferrite layer. Using the systems, methods, and techniques disclosed herein, the need for using complex ceramic machine tools and equipment when processing ferrite materials may be reduced or eliminated.

In example embodiments of the disclosure, ferrite materials, such as ferrite layers or films, may be patterned by cutting. For example, one or more cutting parameters (e.g., thickness) applicable to a specific ferrite material and/or a specific substrate (e.g., semiconductor wafer), such as one or more mechanical characteristics of the specific ferrite material and/or specific substrate (e.g., semiconductor wafer), may be taken into consideration in performing the cutting. For example, a thickness of a ferrite layer may vary between 1 and 500 micrometers depending on the functionality for which it is designed. In some embodiments, a ferrite material may be cut at a shallow cutting depth, such as a depth that is equal or greater than the ferrite layer thickness, but less than a combined depth of the ferrite layer thickness and a thickness of a substrate (e.g., dielectric wafer) upon which the ferrite layer rests. Example substrates (e.g., dielectric wafer) that may be used in relation to the embodiments disclosed herein may have thicknesses that range between 100 and 1,000 micrometers, though the disclosure is not so limited. A thickness of a substate used in accordance with the embodiments disclosed herein may be selected based on mechanical strength considerations, unless the substrate simultaneously performs some other functions, in which case those other functions may be taken into consideration. In some embodiments where the cutting is performed with a blade, such as a dicing wheel, the shallow cutting depth may be a depth that is equal or greater than the ferrite layer thickness plus a curvature radius of the dicing wheel, but less than a combined depth of the ferrite layer thickness and a thickness of a substrate (e.g., dielectric wafer) upon which the ferrite layer rests. A curvature radius of a dicing wheel may equal one half of the blade thickness and may vary widely between different blades. Blades that are between 25 and 5,000 micrometers thick are examples of blades that may be used in cutting a ferrite layer, an optional binder, and a substrate (e.g., dielectric wafer), as disclosed herein, though the disclosure is not so limited.

The ferrite (e.g., ferrite layer, ferrite film) discussed in relation to the example embodiments and figures herein may be made of any of a variety of ferrite materials. Some examples include yttrium iron garnet (YIG), other garnets, hexaferrites, or spinel ferrites, though the disclosure is not so limited.

Although embodiments disclosed herein, and shown in the figures, often refer to an assembly that has a ferrite layer on top of a dielectric wafer, substrates other than a dielectric wafer could be used as the substrate under the ferrite layer. Some example substrates that may be used include barium ferrite and strontium hexagallate. In some embodiments, the substrate may be metallic, such as made of aluminum or of a copper alloy. In some embodiments, the substrate may be made of plastic. In some embodiments, the substrate may be made of silicon, sapphire, glass, or magnesium oxide (MgO) single crystal wafers. One of skill in the art would appreciate that many different materials may be used as the substrate, and the disclosure herein should not be limited to any particular type of substrate.

Embodiments disclosed herein also refer to an optional binder (e.g., binder 106) between the ferrite layer and the substrate. An optional binder may be used to bind the ferrite layer to the substrate. Example materials for an optional binder include, for example, an epoxy or a layer of metal (e.g., gold) that may bond to both the ferrite layer and the substrate. An optional binder may have a thickness that may range from 5 to 100 micrometers, though the disclosure is not so limited.

Cutting, such as the shallow cutting discussed above, may be performed mechanically using a blade, or optically using a LASER, as just some examples. In some embodiments, cutting may be performed using a single or multiple cutting passes using a blade or LASER to adjust dicing streak widths (i.e., width of the cut) according to desired geometries. A dicing streak width may correspond to a width of a cutting mechanism, such as the width of a blade or a width of a LASER beam, plus a little extra width. The amount of extra width may depend on the setup of the system performing the cutting and on the specific material being cut, and may be determined experimentally for each specific application. In some examples, the extra width may be approximately 10% of the blade or LASER beam thickness. In some embodiments, a combination of mechanical (e.g., blade) and optical (e.g., LASER) cutting passes may be used to achieve a desired geometry. For example, a first cut in one direction may be performed by a blade and another cut in another direction may be performed by a LASER. In some embodiments, a cutting depth may be modified between cuts. For example, some cuts may extend all the way through the thickness of a ferrite layer, any binding material between the ferrite layer and substrate (e.g., dielectric wafer), and the substrate (e.g., dielectric wafer) (e.g., so as to singulate a chip), while other cuts may extend through the ferrite layer only, through the ferrite layer and any binding material only, or through the ferrite layer, any binding material, and a portion of a substrate (e.g., dielectric wafer), so as to create smaller features within one or more outer boundaries of a chip, for example.

Example embodiments of the disclosure may be particularly useful for cutting relatively thick (e.g., at least 10 microns) ferrite layers. Such relatively thick ferrite layers may enable compact and efficient designs for inductor cores and radiofrequency devices, including but not limited to magnetostatic wave-based filters.

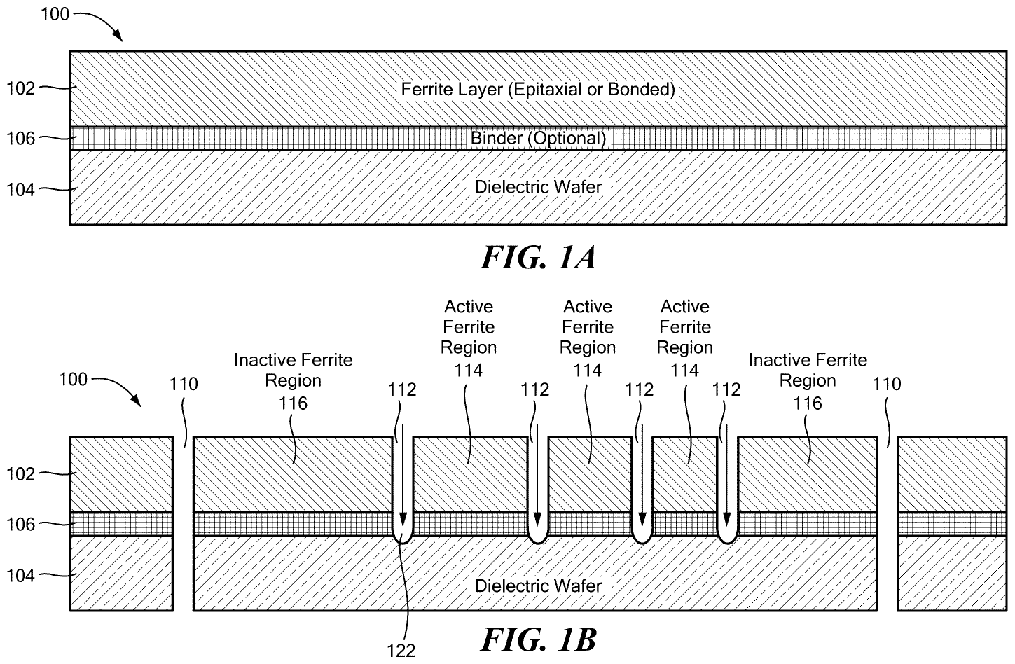

FIG. 1A shows a diagram of a cross-sectional view of an example assembly 100 that includes a ferrite layer 102 on a substrate (shown here as a dielectric wafer 104). In some embodiments, the ferrite layer 102 may be bonded to the dielectric layer 104 by a binder 106. In other embodiments, the ferrite layer 102 may be epitaxially grown on the substrate (e.g., dielectric wafer 104) such that a binder is not needed. For example, the ferrite layer may be formed on the substrate such that the crystal lattices of the ferrite layer and of the substrate are in contact with one another and have a preferred orientation to one another. That is, the process may involve nucleation of the ferrite layer on a substrate, such that the ferrite layer repeats the crystalline structure of the substrate. In some embodiments, ferrite layer 102 may be at least 1 microns in thickness, though the disclosure is not so limited. In some embodiments, ferrite layer 102 may be at least 10 microns in thickness.

FIG. 1B shows a diagram of a cross-sectional view of an example assembly 100 (e.g., assembly 100 of FIG. 1A) after cutting in accordance with example embodiments of the disclosure. Assembly 100 may have one or more first cuts 110 having a first depth and one or more second cuts 112 having a second depth. The first depth and second depths may be different. For example, in the example illustrated in FIG. 1B, two first cuts 110 extend through ferrite layer 102 and binder 106 well into (e.g., at least half way, or in some embodiments even through) the substrate (e.g., dielectric wafer 104). By contrast, the depths of four second cuts 112 in the example illustrated in FIG. 1B are shallower, and are shown as extending through the ferrite layer 102, an optional binder, and a small depth (e.g., not exceeding one half of the width of the blade or one half of the width of the LASER beam) into the substrate (e.g., dielectric wafer 104). In some embodiments, cuts may form active and inactive regions of the ferrite layer in the assembly. For example, as shown in FIG. 1B, first cuts (e.g., cuts 110) and second cuts (e.g., cuts 112) may together form active regions (e.g., active regions 114) and inactive regions (e.g., inactive regions 116) in the assembly (e.g., assembly 100). An active area may serve a radio frequency (RF) or electromagnetic purpose, while an inactive (or “dummy”) area may exist either to enlarge the size of a chip for easier handling or for mechanical interfacing with other parts, for example.

In some embodiments, one or more cuts may extend partially through a ferrite layer, entirely through a ferrite layer and partially into a binder layer (if one exists), through a ferrite layer, a binder layer, and partially into a substrate (e.g., dielectric wafer), or through each layer of the assembly. It is to be understood that each cut may be independent and can correspond to one of the depths described above, and that any number of cuts may be performed on an assembly. In some embodiments, a temporary adhesive may be used to secure a substrate (e.g., dielectric wafer) to a surface of a tool that is being used for cutting the substrate. For example, a substrate (e.g., dielectric wafer 104) may be temporarily secured to a tool with a blade or a tool with a LASER to hold the assembly in place as the assembly is cut. In some embodiments, an assembly may be unsecured, moved, and resecured between cuts to change the positioning of the assembly to perform different cuts.

It will be appreciated by one skilled in the art that the precision of a cut may impact electrical and magnetic performance of the ferrite layer. It will further be appreciated that existing chemical etching processes may lack precision. For example, chemical etching of a ferrite layer may form cuts with rounded corners or other undesirable geometries due to the limited control when etching. In addition, chemical etching does not allow for compound shaping of cuts extending from a top to a bottom of a ferrite layer.

FIG. 1C shows a diagram of a top view of an example assembly with different types of cuts. As shown in the example in FIG. 1C, assembly 100 may have one or more cuts (e.g., cuts 124, 126) in a first direction 118 and one or more cuts (e.g., cuts 128, 130) in a second direction 120. In some embodiments, cuts 124, 126, 128, 130 may represent deeper cuts, such as cuts through the ferrite layer, optional binder, and substrate (see, e.g., cuts 110 of FIG. 1B). As shown in the example in FIG. 1C, assembly 100 may have one or more additional cuts (e.g., cuts 132, 134, 136, 138) in first direction 118 and one or more additional cuts (e.g., cuts 140, 142) in second direction 120. In some embodiments, cuts 132, 134, 136, 138, 140, 142 may represent shallower cuts, such as cuts that pass through the ferrite layer only, through the ferrite layer and optional binder only, or through the ferrite layer, optional binder, and a small depth into the substrate (see, e.g., cuts 112 of FIG. 1B). In some embodiments, the first and second directions may be perpendicular to each other. For example, FIG. 1C shows cuts 124, 126 and additional cuts 132, 134, 136, 138 in a first direction 118 that are perpendicular to cuts 128, 130 and additional cuts 140, 142 in a second direction 120. In some embodiments, the one or more deeper cuts 124, 126, 128, 130 (e.g., cuts 110 of FIG. 1B) may be at the outer regions of the assembly and the one or more shallower cuts 132, 134, 136, 138, 140, 142 (e.g., cuts 112) may be inside the deeper cuts. In some embodiments, the shallower cuts may form the active regions of the assembly.

It is understood that cuts into an assembly may be spaced to form a desired pattern in the ferrite layer of the assembly, in order to form active and inactive regions in the ferrite layer. More particularly, cuts may be made to create one or more active regions and one or more inactive regions having desired dimensions. For example, in some embodiments, cuts may be spaced apart by a distance between 25 and 100 millimeters, though the disclosure is not so limited and the spacing distance may depend on the particular application for which the assembly is being created. In some embodiments, inactive or “dummy” regions may be formed with specific dimensions (e.g., on the same order of magnitude as dimensions of the active regions) to facilitate handling of devices. In some embodiments, one or more active regions may be formed with selected dimensions configured for electrical connections, such as wirebond connections. For example, in some embodiments, the one or more active regions configured for electrical connections may have dimensions that range between 25 and 500 micrometers.

In some embodiments, cuts in an assembly may have a cross-sectional profile that has linear vertical edges that are perpendicular to a major surface of a substrate (e.g., dielectric wafer) of the assembly. In FIG. 1B, for example, cuts 110 and cuts 112 each have a cross-sectional profile with linear vertical edges perpendicular to a major surface of the substrate (e.g., dielectric wafer 104). However, the disclosure is not so limited. In some embodiments, one or more cuts may be made with a geometry that is at least partially non-linear. In some embodiments, one or more cuts may be made with a geometry that is at least partially arcuate.

In some embodiments, cuts in an assembly may have a cross-sectional profile that has linear vertical edges that extend from rounded grooves. In FIG. 1B, for example, cuts 112 each have a cross-sectional profile with linear vertical edges that extend from a rounded groove 122. The rounded groove may correspond to a shape of a blade used to cut the assembly. Such a rounded groove may not exist, for example, in embodiments where cuts are made by a LASER cutting device. Although FIG. 1B shows an example where rounded grooves 122 are formed as a result of the shape of a blade used to cut the assembly, the disclosure is not so limited. One of skill in the art would recognize that blades having a variety of different shapes may be used to cut such an assembly, and the resulting cut would correspond to the shape of the blade used to cut the assembly.

Though FIGS. 1A-1C show example assemblies with example patterns of cuts (e.g., FIG. 1B shows example assembly 100 with four shallow cuts 112 and two deeper cuts 110), the disclosure is not so limited. An assembly may be patterned with any number of shallow and/or deep cuts, and may be patterned with any combination of different geometries of cuts, and these various ways of patterning an assembly should be considered to be within the scope of the disclosure herein.

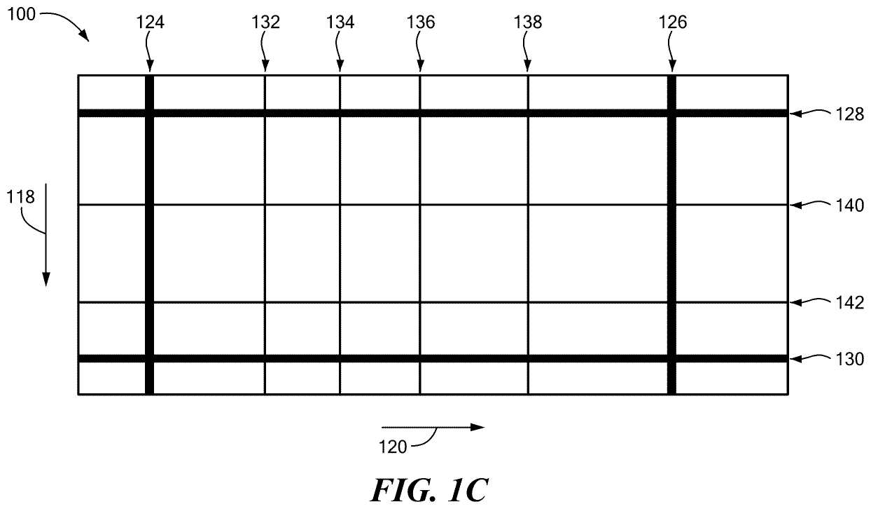

FIG. 2A shows a diagram of an example assembly 200 having one or more wedge-shaped cuts 202 in a ferrite layer 204. As shown in FIG. 2A, a wedge-shaped cut (e.g., cut 202) may be cut such that a bottom of the cut is wider than an opening of the cut at a top surface of the ferrite layer. In some embodiments, the wedge-shape of the cut may be defined by a profile of a blade or LASER beam used to perform the cut. In some embodiments, the openings of the cuts in the example shown in FIG. 2A may have the same dimensions as those discussed above with respect to FIGS. 1B and 1C, though the disclosure is not so limited. In some embodiments, the sidewalls of the cuts 202 may each be angled at approximately a 45 degree angle from the planar top of the ferrite layer, though the disclosure is not so limited. In some embodiments, the angular shape of the wedge-shaped cuts in FIG. 2A may reduce demagnitization effects around the edge of the active areas and may help to expand the available operating frequencies of an RF device in which the assembly is to be used.

FIG. 2B shows a diagram of an example assembly 210 having one or more wedge-shaped cuts 212 in a ferrite layer 204. As shown in FIG. 2B, a wedge-shaped cut (e.g., cut 212) may be cut such that a bottom of the cut is narrower than an opening of the cut at a top surface of the ferrite layer. In some embodiments, the wedge-shape of the cut may be defined by a profile of a blade or LASER beam used to perform the cut. In some embodiments, the openings of the cuts in the example shown in FIG. 2B may have the same dimensions as those discussed above with respect to FIGS. 1B and 1C, though the disclosure is not so limited. In some embodiments, the sidewalls of the cuts 212 may each be angled at approximately a 45 degree angle from the planar top of the ferrite layer, but angled in the opposite direction than as shown in FIG. 1B, though the disclosure is not so limited. In some embodiments, the angular shape of the wedge-shaped cuts in FIG. 2B may reduce demagnitization effects around the edge of the active areas and may help to expand the available operating frequencies of an RF device in which the assembly is to be used.

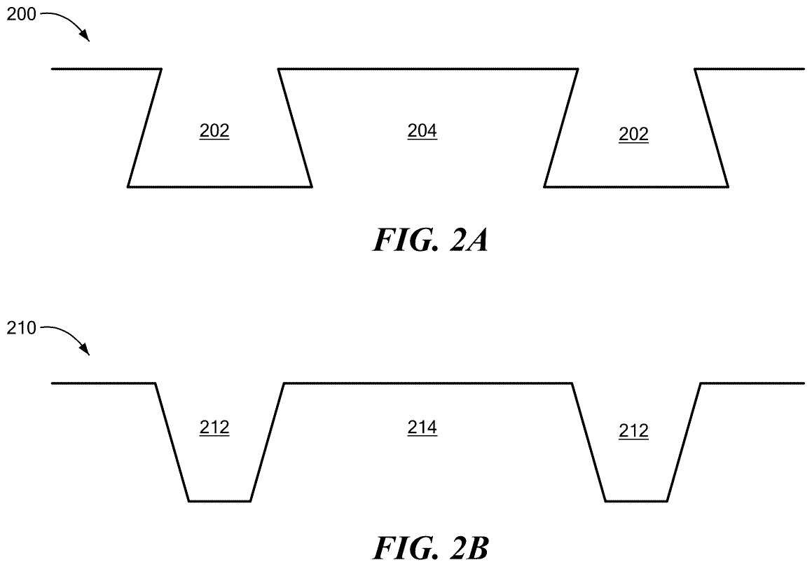

FIG. 3A shows a diagram of an example assembly 300 having a ferrite layer 302, a dielectric wafer 304, and an optional binder 306. A cut in an assembly may have one or more beveled edges at the top of a ferrite layer. For example, the example shown in FIG. 3A shows a cut 310 in an assembly 300 that has beveled edges 320 at an opening of the cut at the top of ferrite layer 302. In some embodiments, each of the beveled edges may be formed at about a 45 degree angle from the planar top of the ferrite layer, though the disclosure is not so limited. In some embodiments, each of the beveled edges may correspond to approximately 10% of the overall depth of a cut 310, though the disclosure is not so limited. In some embodiments, the shape of a cut 310 in an assembly 300 may help to reduce edge chipping that may be caused by the cutting operations and that may be detrimental to performance of an RF device in which the assembly is to be used.

FIG. 3B shows a diagram of an example assembly 320 having a ferrite layer 322, a dielectric wafer 324, and an optional binder 326. A cut in an assembly may have one or more V-shapes that extend through a ferrite layer. For example, the example shown in FIG. 3B shows a cut 330 in assembly 320 that is V-shaped and that extends through ferrite layer 322, optional binder 326, and a short depth into the substrate (e.g., dielectric wafer 324). In some embodiments, each side of the V-shaped cut may be formed at about a 45 degree angle from the planar top of the ferrite layer, though the disclosure is not so limited. In some embodiments, a cut 330 may extend deeper into the assembly than the cuts described above with respect to FIGS. 1B, 2A, 2B, and 3A, though the disclosure is not so limited. In some embodiments, a cut 330 may be used to define an outer perimeter of a singulated chip, though the disclosure is not so limited.

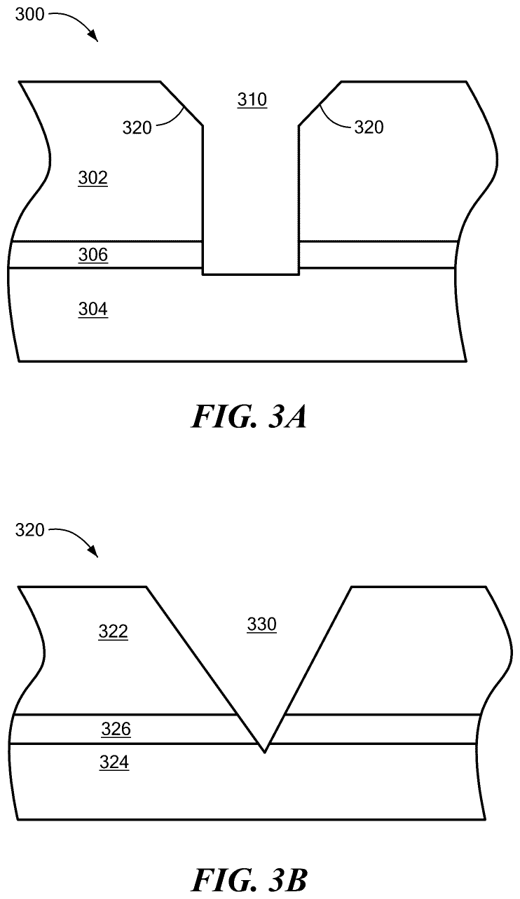

FIG. 4A shows a diagram of an example assembly 400 having a ferrite layer 402, a substrate (e.g., dielectric wafer 404), and an optional binder 406. A cut in the assembly may be a compound cut having any number of surfaces at any number of angles. For example, the example shown in FIG. 4A shows a cut 410 in assembly 400 that is a compound cut having a first surface 412a, a second surface 412b, a third surface 412c, a fourth surface 412d, and a bottom surface 414. Bottom surface 414 is shown in the example in FIG. 4A as being formed in the substrate (e.g., dielectric layer 404). In the example shown in FIG. 4A, first surface 412a and second surface 412b together form a first side of cut 410, and third surface 412c and fourth surface 412d together form a second side of cut 410. In some embodiments, first surface 412a may be parallel to third surface 412c, and second surface 412b may be parallel to fourth surface 412d. In these embodiments, cut 410 may be made with two passes of a cutting tool by orienting the cutting mechanism (e.g., blade, LASER beam) in different orientations (e.g., opposite orientations) for the two passes. In some embodiments, each of the first surface 412a, second surface 412b, third surface 412c, and fourth surface 412d may each be formed at about a 45 degree angle from the planar top of the ferrite layer, though the disclosure is not so limited. In some embodiments, a cut 410 may offer a performance benefit in certain applications over the cuts described with respect to FIGS. 1B, 2A, 2B, 3A, and 3B.

FIG. 4B shows a diagram of a cross-sectional view of an example assembly 420 having a ferrite layer 422, a substrate (e.g., dielectric wafer 424), and an optional binder 426. In the example shown in FIG. 4B, a cut 430 in assembly 420 may be a compound cut having a first surface 432a, a second surface 432b, a third surface 432c, a fourth surface 432d, and a bottom surface 434 formed in the substrate (e.g., dielectric layer 424). In the example shown in FIG. 4C, first surface 432a and second surface 432b 432 form a first side of cut 430, and third surface 432c and fourth surface 432d form a second side of the cut. In some embodiments, first surface 432a and third surface 432c may be parallel to each other, and second surface 432b and fourth surface 432d may be parallel to each other. In some embodiments, the first surface 432a, second surface 432b, third surface 432c, and fourth surface 432d may each be formed at about a 45 degree angle from the planar top of the ferrite layer, though the disclosure is not so limited. In some embodiments, a cut 430 may offer a performance benefit in certain applications over the cuts described with respect to FIGS. 1B, 2A, 2B, 3A, 3B, and 4A.

FIG. 4C shows a diagram of example orientations of a cutting mechanism of a cutting tool for performing multiple passes to make a make a cut (e.g., cut 410 of FIG. 4A, cut 420 of FIG. 4B). A cutting mechanism may be positioned into a first orientation 417 for a first pass (i.e., first cut) and into a second orientation 419 for a second pass (i.e., second cut), or vice versa. For example, a cutting mechanism may be positioned into a first orientation 417 to form first surface 412a and third surface 412c as shown in FIG. 4A, and may be positioned into a second orientation 419 to form second surface 412b and fourth surface 412d as shown in FIG. 4A. As another example, a cutting mechanism may be positioned into a first orientation 417 to form second surface 432b and fourth surface 432d, and may be positioned into a second orientation 419 to form first surface 432a and third surface 432c.

In some embodiments, a cutting mechanism for making a particular cut may be selected based on one or more characteristics of the cutting mechanism. For example, a profile of a blade for a particular cut may be selected based on its shape, edge shape, grit (e.g., particle size), binder (e.g., resin vs. metal), width (i.e., thickness), radius, angle, cut depth, or rotational speed (revolutions per minute (rpm)) to make a cut with a desired geometry. In some embodiments, a profile of a blade may be selected based on one or more abrasive characteristics of the blade. For example, a blade may consist of a grinding medium (e.g., diamond powder, silicon carbide (SiC) power, etc.) and a binder (e.g., resin, metal). Abrasive parameters may be determined by the particle size of the grinding medium (e.g., diamond) as well as the type of binder. For example, a blade with a larger particle size and a softer binder (e.g., resin) may cause more edge chipping when used in cutting ferrite layers than some other types of blades. In some embodiments, a high grit (e.g., fine particle size), metal bonded (vs. resin), high rpm (e.g., up to 100,000 rpm) blade may be desired to reduce edge chipping in cutting a ferrite layer. In some embodiments, a blade may be 2 inches, 4 inches, 8 inches, or more in diameter. In some embodiments, smaller diameter blades rated for higher rpms may be more desirable in cutting a ferrite layer. However, larger diameter blades may last longer and allow for more economical operations, so there may be tradeoffs between selecting a smaller diameter blade and a larger diameter blade. An edge shape of a blade may be square, round, or V-shaped, as just some examples.

As another example, a profile of a LASER beam for a particular cut may be selected based on its beam shape, beam width, energy, power, or wavelength, as just some examples. In some embodiments, a Master Oscillator Power Amplifier (MOPA) LASER type or fiber LASER type may be selected, though the disclosure is not so limited. In some embodiments, a LASER type that operates at between 1 and 10 Watts of power may be selected, though the disclosure is not so limited and the power may be selected depending on the particular application, such as cut depth. In some embodiments, a LASER type with an operating frequency between 1 and 4,000 kHz may be selected, though the disclosure is not so limited. In some embodiments, a LASER type with a pulse duration of between 2 and 350 nanoseconds may be selected, though the disclosure is not so limited.

It is to be understood that any practical number of passes with a cutting mechanism (e.g., blade, LASER beam) can be performed to achieve a desired cut geometry. Additionally, different blade passes may have different blade orientations, e.g., blade angle, cut depth, blade rotational speed to achieve a desired cut geometry. Different passes may also use different cutting mechanisms (e.g., different blades or LASER beams) having different characteristics, such as different widths, shapes, abrasive parameters, teeth per unit length, etc. to achieve a desired cut geometry.

In some embodiments, one or more cuts in a ferrite layer may have a geometry configured to achieve certain electrical operating characteristics. For example, shallow cuts may define a parallelepiped ferrite region. As compared to a rectangular ferrite region, a parallelepiped ferrite region may scatter magnetostatic waves that would otherwise reflect and induce undesired destructive interference. For example, a parallelepiped geometry of a ferrite layer with sharp angles (e.g., approximately 45 degrees) may facilitate magnetostatic wave scattering, when that is desirable.

In some embodiments, one or more cuts in a ferrite layer may be made at one or more selected locations to reduce strain in a lattice structure of the ferrite layer. It will be appreciated that thick ferrite layers (e.g., layers more than 10 microns thick) may be more susceptible to mechanical strain than thinner ferrite layers. This may particularly apply to epitaxial ferrite films, where strain arises from lattice constant mismatches between a substrate (e.g., dielectric wafer) and an epitaxial ferrite film. Strain may also arise due to thermal coefficient differences between a substrate (e.g., dielectric wafer) and a ferrite layer. In some embodiments, cuts in a ferrite layer may be made at intervals to reduce strain in the lattice structure of the ferrite layer. The number and location of the cuts may depend on the particular assembly or application in which the assembly is to be used. As one example, in some assemblies or applications a cut at a geometrical center of an assembly may reduce strain by about a factor of two, though the disclosure is not limited to these assemblies or applications.

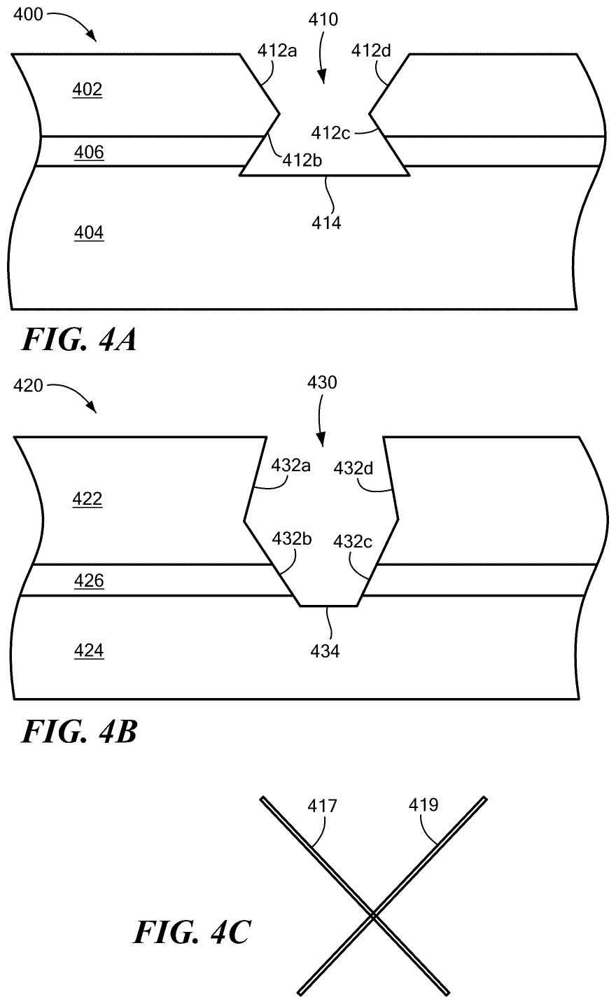

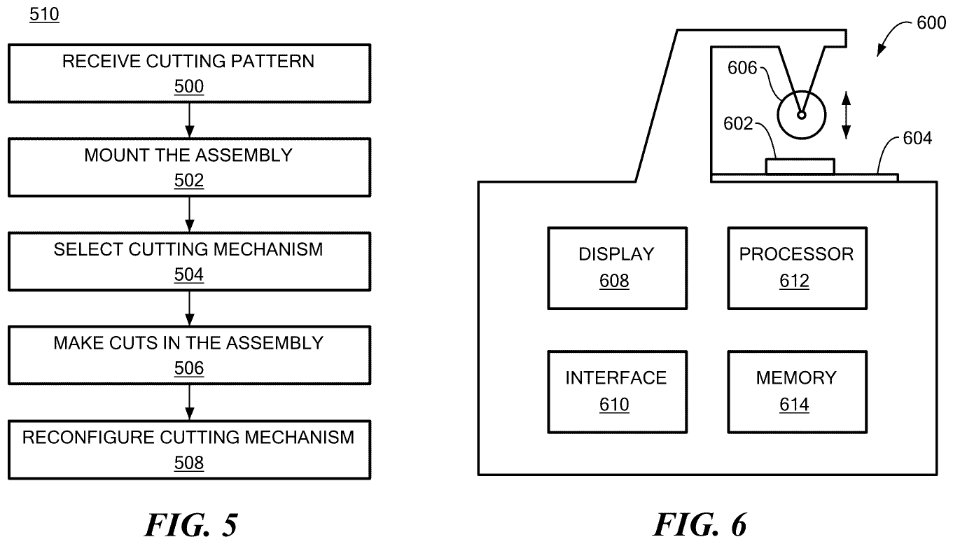

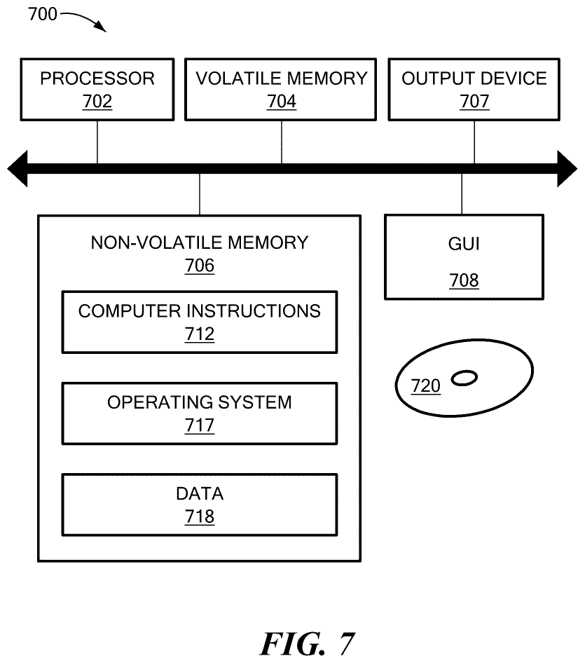

FIG. 5 shows a flow diagram of an example process 510 for patterning an assembly with a ferrite layer, consistent with embodiments of the present disclosure. Process 510 may be performed, for example, by one or more systems (e.g., system 600 of FIG. 6) or by one or more computing devices (e.g., computing device 700 of FIG. 7). In some embodiments, portions of process 510 may be performed by one or more systems and other portions of process 510 may be performed by one or more computing devices. In some embodiments, portions of process 510 may be performed by one or more humans or machines (e.g., robots) and other portions of process 510 may be performed by one or more systems and/or computing devices.

At 500, a pattern for cutting an assembly (e.g., (e.g., assembly 100, assembly 200, assembly 210, assembly 300, assembly 320, assembly 400, assembly 420) having a ferrite layer may be received. The pattern may, for example, be received from a memory in a system (e.g., system 600 of FIG. 6) or computing device (e.g., computing device 700 of FIG. 7). Such a system or computing device may store (e.g., in memory) a number of different patterns for making different types of cuts in different positions of a ferrite, and a system or computing device may receive information (e.g., a data file) regarding a pattern to be used for a particular assembly from the memory in response to a prompt from a user, system, or computing device.

At 502, an assembly may be mounted on a system with equipment (e.g., cutting mechanism(s)) for forming one or more cuts at one or more locations defined by the pattern. In some embodiments, the assembly may comprise a ferrite layer bonded to a substrate (e.g., dielectric wafer) with a binder material. In other embodiments, the assembly may comprise a ferrite layer that was grown on the substrate (e.g., dielectric wafer).

At 504, a cutting mechanism may be selected based on one or more characteristics of one or more cuts that are to be formed in the assembly. For example, a blade may be selected based on one or more characteristics of a cut to be formed in the assembly. In some embodiments, a straight blade may be selected to form one or more cuts that have parallel surfaces formed in the ferrite layer. In other embodiments, a blade having a particular shape and geometry corresponding to a profile of a desired cut may be selected. As another example, a LASER beam may be selected based on one or more characteristics of a cut to be formed in the assembly. In some embodiments, a particular type of LASER beam may be selected to form one or more cuts that have parallel surfaces formed in the ferrite layer. In other embodiments, a laser beam having a particular shape and geometry corresponding to a profile a desired cut may be selected.

In some embodiments, multiple blades may be selected and used simultaneously to form a cut having a desired geometry in an assembly. The multiple blades may have the same or different characteristics. In other embodiments, multiple LASER beams may be selected and used simultaneously to form a cut having a desired geometry in an assembly. The multiple LASER beams may have the same or different characteristics.

In some embodiments, where multiple cuts are to be made in an assembly (e.g., assembly 100 of FIG. 1B), multiple sets of one or more blades or one or more LASER beams may be selected and utilized on the assembly simultaneously so as to form the multiple cuts at the same time. For example, four blades or LASER beams having the same characteristics may be selected and utilized simultaneously to form the four cuts 112 in example assembly 100 of FIG. 1B.

In some embodiments, 504 may occur before 502. For example, where different systems have different cutting tools with different cutting mechanisms (e.g., some with different types of blades, some with different types of LASER beams), the particular cutting tool and cutting mechanism to be used may be selected before the assembly is mounted on a system having the selected cutting tool and cutting mechanism.

In 506, the assembly mounted on the system, and/or the cutting mechanism (e.g., blade, LASER beam) may be manipulated to form one or more cuts in the assembly in accordance with the received pattern. For example, a cutting tool (e.g., saw, grinder) with a blade may be turned on such that the blade is rotating, and the blade may be lowered into the assembly to make a cut. As another example, a LASER system may be powered on such that a LASER beam etches a cut into the assembly. In some embodiments, the assembly may be moved (e.g., back and forth or rotated) between cuts so as to position the assembly for one or more cuts. In some embodiments, multiple passes may be performed to make the one or more cuts, as discussed above with respect to FIG. 4C. In some embodiments, the one or more cuts may form one or more active and/or inactive regions of a ferrite layer of the assembly.

In optional step 508, the cutting mechanism may be reconfigured to perform another one or more cutting passes of the assembly. For example, the cutting mechanism may be reconfigured into another orientation to perform one or more additional cutting passes, as discussed above with respect to FIG. 4C. Reconfiguring the cutting mechanism may involve moving a blade or exit point of a LASER beam back and forth or side to side, or rotating the blade or exit point of the LASER beam (e.g., to make a miter, bevel, or compound cut). In some embodiments, the one or more additional cutting passes may be performed, for example, to form a compound cut in a ferrite layer of the assembly to achieve desired RF operating characteristics, such as discussed above with respect to FIGS. 4A-4C. In some embodiments, reconfiguration of the cutting mechanism may involve changing the blade and/or LASER beam, or changing from a blade to a LASER beam, for performing the additional one or more cutting passes. In some embodiments, reconfiguration of the cutting mechanism may involve moving the assembly to another system that has a cutting tool with a cutting mechanism suitable for making the one or more additional cutting passes of the assembly.

FIG. 6 shows a diagram of an example system 600 for cutting one or more assemblies 602 (e.g., assembly 100, assembly 200, assembly 210, assembly 300, assembly 320, assembly 400, assembly 420) consistent with embodiments of the present disclosure. An assembly 602 may be secured to a cutting surface 604 of system 600 to enable a cutting mechanism 606 (e.g., blade, LASER beam) to cut the assembly in accordance with a selected pattern, as described above. System 600 may include a display 608 (e.g., light-emitting diode (LED) display, liquid crystal display (LCD), touch screen display) and an interface 610 (e.g., Ethernet interface, WiFi interface, Universal Serial Bus (USB) interface) to receive cutting patterns exchange other information. A memory 614 may be configured to store instructions for performing a process (e.g., process 500) for cutting an assembly, one or more patterns, and other information (e.g., look-up tables). A processor 612 may control the cutting tool and cutting mechanism 606 and/or cutting surface 604 of system 600 to manipulate assembly 602 to effect the selected pattern.

FIG. 7 shows an example computer 700 that may perform at least part of the processing described herein to pattern an assembly in accordance with example embodiments of the disclosure. The computer 700 may include a processor 702, a volatile memory 704, a non-volatile memory 706 (e.g., hard disk), an output device 707 and/or a graphical user interface (GUI) 708 (e.g., a mouse, a keyboard, a display, for example). Non-volatile memory 706 may store computer instructions 712 for performing one or more processes (e.g., process 500 of FIG. 5), an operating system 716, one or more patterns, and other data 718. In one example, the computer instructions 712 are executed by the processor 702 out of volatile memory 704. In one embodiment, an article 720 comprises non-transitory computer-readable instructions that may be executed by processor 702 to perform one or more processes (e.g., process 500 of FIG. 5).

Processing may be implemented in hardware, software, or a combination of the two. Processing may be implemented in one or more computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system may perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as special purpose logic circuitry (e.g., an FPGA (field programmable gate array) and/or an ASIC (application-specific integrated circuit)).

Various embodiments of the concepts, systems, devices, structures, and techniques sought to be protected are described herein with reference to the related drawings. Alternative embodiments can be devised without departing from the scope of the concepts, systems, devices, structures, and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” “some embodiments,” etc., indicate that the embodiment(s) described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, relative terms, such as “upper,” “lower,” “right,” “left,” “vertical,” “horizontal, “top,” “bottom,” and derivatives thereof shall relate to the described structures and methods, as oriented in the example figures so as to facilitate an understanding of the invention as claimed and not to limit the scope of the claims in any way. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” substantially,” and “about” may be used to mean within ±5% of a target value in embodiments unless described in some other way., within ±10% of a target value in some embodiments, within ±5% of a target value in some embodiments, and yet within ±2% of a target value in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method, comprising:
receiving a pattern for an assembly having a ferrite layer and a dielectric layer; and
mechanically or optically making cuts in the ferrite layer to form active regions of the ferrite layer and inactive regions of the ferrite layer.

2. The method according to claim 1, wherein first ones of the cuts extend partially into the dielectric layer.

3. The method according to claim 2, wherein second ones of the cuts extend at least half way through the dielectric layer.

4. The method according to claim 1, wherein the assembly comprises a binder between the ferrite layer and the dielectric layer.

5. The method according to claim 1, wherein the ferrite layer is at least 1 microns in thickness.

6. The method according to claim 1, wherein at least one of the cuts in the ferrite layer is configured to relieve strain in a lattice of the ferrite layer.

7. The method according to claim 1, further including selecting a profile of a blade or LASER beam for making at least some of the cuts.

8. The method according to claim 7, further including selecting a profile of a blade for making at least some of the cuts, wherein selecting the profile of the blade includes selecting an abrasive characteristic of the blade.

9. The method according to claim 7, wherein selecting the profile includes selecting a shape of the blade or LASER beam for some of the cuts to have a particular geometry.

10. The method according to claim 9, wherein the particular geometry is at least partially non-linear.

11. The method according to claim 9, wherein the particular geometry is at least partially arcuate.

12. The method according to claim 9, wherein the particular geometry requires at least two passes by the blade or LASER beam.

13. The method according to claim 1, wherein at least some of the cuts are beveled.

14. The method according to claim 1, wherein at least some of the cuts are configured for at least one radio frequency (RF) operating characteristic.

15. The method according to claim 7, further including selecting a profile of a LASER beam for making at least some of the cuts, wherein selecting the profile of the LASER beam includes selecting one of a wavelength of the LASER beam, an energy of the LASER beam, or a shape of the LASER beam.

16. The method according to claim 7, further including selecting a profile of a LASER beam for making at least some of the cuts, wherein selecting the profile of the LASER beam includes selecting a shape of a beam for some of the cuts to have a particular geometry.

17. A system, comprising:
a memory storing instructions; and
one or more processors that, when executing the instructions, are configured to:
receive a pattern for an assembly having a ferrite layer and a dielectric layer; and
mechanically or optically make cuts in the ferrite layer to form active regions of the ferrite layer and inactive regions of the ferrite layer.

18. The system according to claim 17, wherein first ones of the cuts extend partially into the dielectric layer.

19. The system according to claim 18, wherein second ones of the cuts extend at least half way through the dielectric layer.

20. The system according to claim 17, wherein the assembly comprises a binder between the ferrite layer and the dielectric layer.

21. The system according to claim 17, wherein the ferrite layer is at least 1 microns in thickness.

22. The system according to claim 17, wherein at least one of the cuts in the ferrite layer is configured to relieve strain in a lattice of the ferrite layer.

23. The system according to claim 17, wherein the system is further configured for a profile of a blade or LASER beam for making at least some of the cuts.

24. The system according to claim 23, wherein the profile of the blade includes an abrasive characteristic of the blade.

25. The system according to claim 23, wherein the profile includes a shape of the blade or LASER beam for some of the cuts to have a particular geometry.

26. The system according to claim 25, wherein the particular geometry is at least partially non-linear.

27. The system according to claim 25, wherein the particular geometry is at least partially arcuate.

28. The system according to claim 25, wherein the particular geometry requires at least two passes by the blade or LASER beam.

29. The system according to claim 17, wherein at least some of the cuts are beveled.

30. The system according to claim 17, wherein at least some of the cuts are configured for at least one radio frequency (RP) operating characteristic.
